(19) United States
(12) Patent Application Publication
(10) Pub. No.: US 2025/0144450 A1
(43) Pub. Date: May 8, 2025

(54) ROPE WRENCH

(71) Applicant: International Safety Components Ltd, Bangor (GB)

(72) Inventor: Kevin Brown, Bangor (GB)

(21) Appl. No.: 18/387,551

(22) Filed: Nov. 7, 2023

(30) Foreign Application Priority Data
Sep. 9, 2022 (GB) 2213237.7

(51) Int. Cl. A62B 1/14; A62B 35/00

(52) U.S. Cl. CPC A62B 1/14; A62B 35/0037

(57) ABSTRACT

A rope wrench comprising or including a base plate having a lever arm at one end and a lever handle opposite the lever arm, a pair of bollards at the lever arm end for receiving therebetween an anchored climbing rope, and a gate spaced from the back plate and pivotable about one of the bollards, thereby permitting mid-rope access to the bollards when open and preventing mid-rope detachment when closed, the arrangement being such that when the gate is closed and the lever arm is rotated by the handle about the major axis of one of the bollards they collectively cause the rope to assume a serpentine shape to shorten the effective length of the main rope and assist ascent by the climber or to impart friction to the rope when descending whereby to permit controlled descent.

This application claims priority to British Patent Application No. 2213237.7 filed on Sep. 9, 2022, the disclosure of which is incorporated herein by reference.

### TECHNICAL FIELD

This invention relates to rope wrenches of the type used by arborists in which a rigid lever arm with a pair of rope-receiving bollards and integral lever handle, collectively a “rope wrench”, provides a mechanical advantage which allows the climber to more easily ascend a climbing rope or descend in a controlled manner.

### BACKGROUND

Rope wrenches are derived from the simple concept of trapping an anchored rope between a pair of bollards at one end of a lever arm such that when the lever arm is rotated orthogonal to the major axis of the bollards the rope assumes a serpentine or generally “S” shaped configuration, thereby causing increased frictional resistance as the climber descends the rope.

Rope wrenches of the type used by arborists are used primarily to provide a residual amount of friction when the primary rope clamping method (eg, a hitch cord) is released, thereby providing a more controlled method of descent. In order to ensure that the climbing rope remains captured the rope wrench itself is comprised of a pair of side frames or plates which surround respective ends of a pair of bollards between which the climbing rope is threaded before use, usually after the climbing rope has been anchored at one end, such as by means of a loop over a sturdy tree branch in the case of arborists. Although this arrangement of capturing the climbing rope is useful in ensuring that the rope wrench is always conveniently available for use by the climber it has two distinct disadvantages, the first being that it requires the free end of the anchor rope to be threaded between the bollards before any ascent of the rope is undertaken such that the rope wrench cannot be attached to the anchored rope by the arborist while in the tree and the second being that it does not easily cater for climbing ropes of different diameters or materials such that in order to achieve a close fit as between the bollards and the rope a range of bollards of different sizes are required or, alternatively, a range of rope wrenches with bollards of different sizes are required, in each case the choice having to be made before the ascent of the rope is made.

### SUMMARY

The foregoing problem has been largely solved by an adjustable rope wrench known as the Notch Flow rope wrench in which the distance between the bollards can be adjusted by means of an Allen-headed threaded fastener and attendant Allen key, the bollard being slidable along a slot of length corresponding to the required range of adjustment, whereafter it can be retained in a chosen position by the use of the Allen key to tighten the bollard against the slot. The rope wrench also includes a releasable fastener called a slic pin to unlock by hand one side plate relative to the other, thereby allowing access between the bollards from the side rather than being threaded from one end, the slic pin having a latch for releasably locking it to the rope wrench. This is a useful improvement but again has the disadvantage in that the adjustment itself requires the climber to carry an Allen key and if the adjustment is made at height there is the obvious risk of dropping or otherwise losing the Allen key unless it is tethered. Similarly, although the provision of a slic pin permits the rope wrench to be attached and detached at height it requires the use of both hands and some dexterity. As with the Allen key, there is also the risk that the slic pin is dropped during the adjustment process.

The present invention is derived from the realisation that there is a need for an alternative approach in which the foregoing disadvantages are obviated.

According to the invention there is provided a rope wrench comprising or including a base plate having a lever arm at one end and a lever handle opposite the lever arm, a pair of bollards at the lever arm end for receiving therebetween an anchored climbing rope, and a gate spaced from the back plate and pivotable about one of the bollards, thereby permitting mid-rope access to the bollards when open and preventing mid-rope detachment when closed, the arrangement being such that when the gate is closed and the lever arm is rotated by the handle about the major axis of one of the bollards they collectively cause the rope to assume a serpentine shape to shorten the effective length of the main rope and assist ascent by the climber or to impart friction to the rope when descending whereby to permit controlled descent.

With this arrangement a climber can attach or detach the rope wrench from the anchored climbing rope by means of the gate without having to thread it between the bollards from its free end, in the case of one known prior art rope wrench, or otherwise removing a removable fastener such as a slic pin to allow removal of one side of the rope wrench and permit insertion or removal of the rope and adjustment of the distance between the bollards by the use of an Allen key, in the case of the other known prior art rope wrench, neither of which are convenient when working at height, whereas with the arrangement of the invention the rope wrench can be easily attached or detached as required by the provision of a side gate pivotable about one of the bollards and without using any tools or removing any fasteners and therefore without the risk of them being dropped or otherwise mishandled.

Preferably, the gate includes a hand-operated latch by which to secure it in its closed position for use and with which to open the gate when the rope wrench is being attached or detached from an anchored rope.

Most preferably, one of the two bollards includes a rotatable cam by which to vary the distance between them to suit rope diameter or rope type. Conveniently, the bollard with the cam includes a spring-biased indexing arrangement whereby particular angular positions of the cam can be selected as required, such as an indexing arrangement comprising a pip and socket-type of arrangement but in which the pip is replaced with a locking pin selectively engageable in one of a series of sockets, or vice versa as the case may be, by pulling the bollard away from the base plate, axially rotating it to a required angular position and releasing it, whereby to temporarily lock the bollard in the new position. This is a particularly useful feature since it allows the climber to quickly adjust the rope wrench to the rope thickness and/or type without using any hand tools, the gate also being openable and closable by hand with a suitable hand-operated latching arrangement.

### BRIEF DESCRIPTION OF DRAWINGS

The invention will now be described, by way of example only, with reference to the accompanying drawings, in which:

FIG. 1 is a perspective view of a rope wrench according to the invention in its closed position,

FIG. 2 is a perspective view of the rope wrench of FIG. 1 in its open position,

FIG. 3 shows the rope wrench of FIG. 1 in its open position and engaged with a climbing rope, the rope wrench also including a rigid tether at one end,

FIG. 4 shows the rope wrench and rope arrangement of FIG. 3 in its closed position,

FIG. 5 shows the rope wrench and rope arrangement of FIG. 3 being used to induce serpentine bending in the rope, and

FIG. 6 is an exploded view of the rope wrench of FIG. 1.

### DETAILED DESCRIPTION

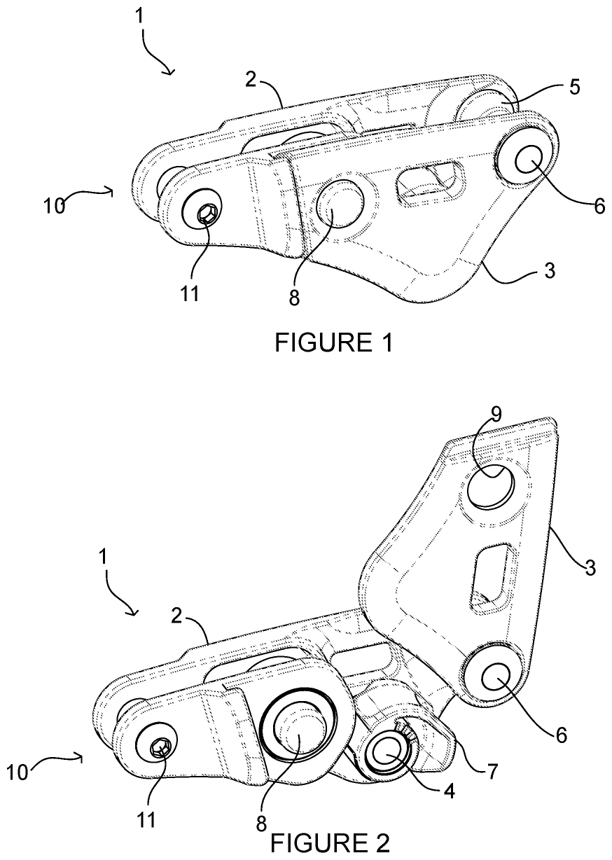

Turning firstly to FIGS. 1 & 2 there is shown a rope wrench 1 which comprises a base plate 2 and a front gate 3 between which are provided a first bollard 4 extending from the base plate 2 and a second bollard 5 mounted on a spindle 6 also extending from the base plate 2 and through the gate 3, the closed end of the spindle 6 securing the gate 3 to the base plate 2 whilst allowing the gate to swing open when required. Extending radially outwardly from the first bollard 4 is a cam 7 rotatable about the axis of the first bollard 4 and by which to permit the effective distance between the bollards 4, 5 to be adjusted in a manner to be described.

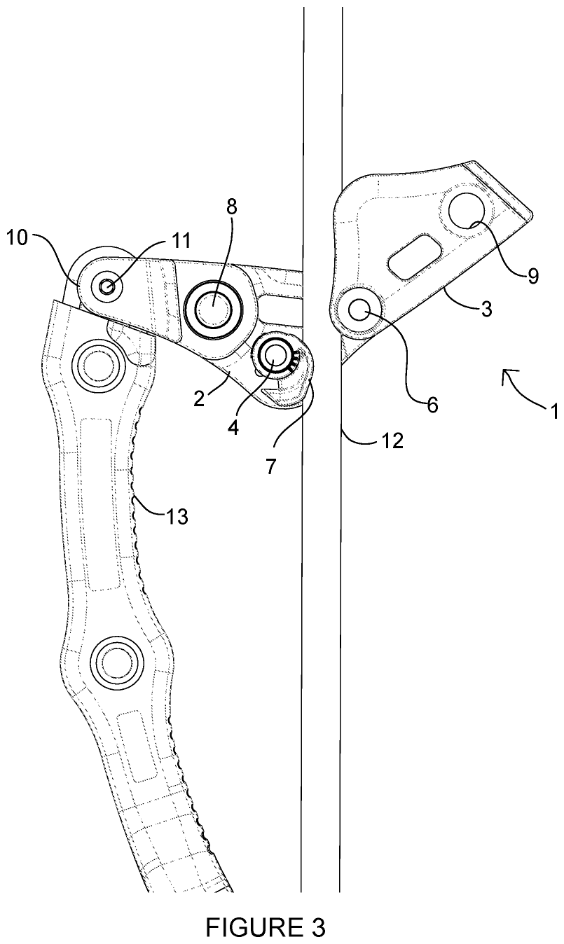

Also extending from the base plate 2 is a spring-loaded detente button 8, co-operable with an aperture 9 in the gate 3 when in the closed position shown in FIG. 1 which collectively are used as latch means to releasably lock the gate 3 in its closed position, subsequent finger pressure on the button 8 permitting the gate 3 to be opened as is shown in FIG. 2. At the end of the base plate 2 remote from the bollards is a yoke 10 between the prongs of which extend an attachment link pin 11 by which to connect the yoke 10 and hence the whole of the rope wrench 1 to a coupling such as a tether 13 as shown in FIG. 3 et. seq.

As will be apparent to those skilled in the art, because the distance between the bollards 4,5 is less than the distance between the first bollard 4 and the yoke 10 at the end of the base plate 2, rotation of the latter about the major axis of the bollard 4 provides a mechanical advantage to the bollard 5 whereby to shorten the trailing end of the rope and permit a climber to more easily ascend the rope towards its anchored end, or to descend in a controlled manner as described later. Thus, in this patent specification the area of the base plate 2 between the bollards 4, 5 acts as a lever arm and the area between the first bollard 4 and the yoke 10 acts as a lever handle by which to obtain a mechanical advantage, although it will be understood that the presence of a yoke 10 is optional.

FIG. 3 shows the rope wrench 1 in its open position corresponding to that shown in FIG. 2 and receiving a climbing rope 12 optionally already under tension, such as by being temporarily attached to a rope ascender connected to the harness of a climber or by the use of foot hitches by which the climber can temporarily grip the rope and ascend by successive leg articulation. In this open position the respective distances between the bollards 4, 5 can be adjusted by lifting and then rotating the cam 7 to match the diameter of the rope 12 or the type of rope if it is significantly compressible whereby to effectively reduce its diameter or thickness to thereby adjust the amount of friction between the rope and the bollards 4, 5. The cam 7 also has a curved cross-section by which to increase the surface area in contact with the rope and its angular position relative to the first bollard 4 can be selected in a manner to be described.

FIG. 3 also shows the use of a rigid tether 13 attached to the yoke 10 via the link pin 11, whereby to remotely operate the rope wrench 1 by hand when the gate 3 is in its closed condition by alternately pushing the rope wrench up the rope and then pulling the yoke end down to induce a serpentine kink in the rope to thereby raise the climber, who can then remain in the new position by being supported by the or each foot hitch and/or a rope ascender attached to the climber's harness or, when descending the rope 12 the serpentine kink imparts friction between the bollards 4, 5 whereby to permit a climber to control the speed of descent.

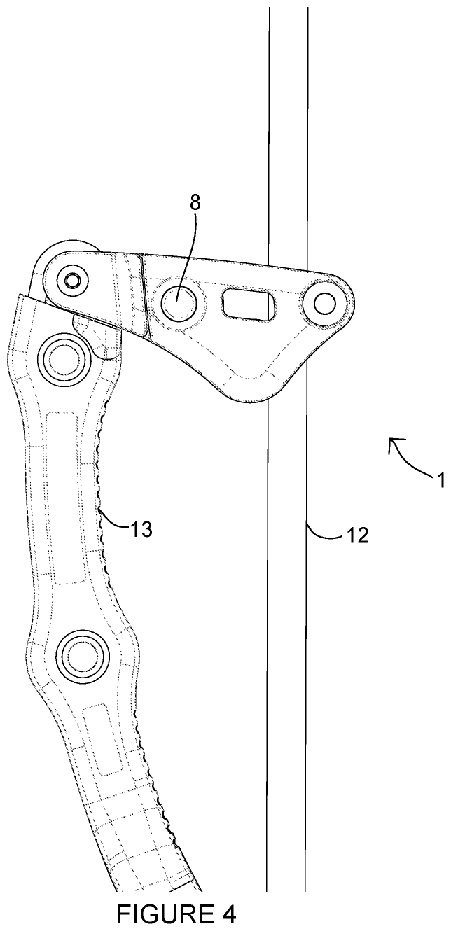

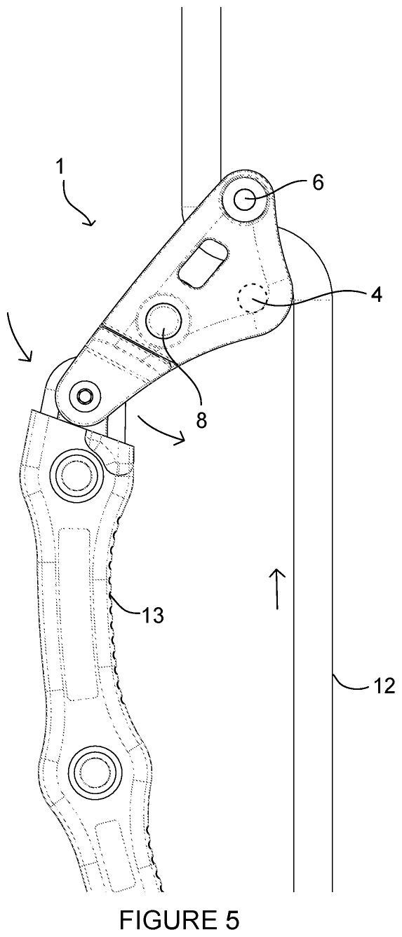

FIG. 4 shows the closed condition of the rope wrench 1 in which it can freely slide up and down the rope 12 and FIG. 5 shows the condition in which the tether 13 has been pulled downwards causing the rope wrench 1 to rotate about the axis of the first bollard 4 to induce serpentine bending of the rope 12 into a generally “S” shape. As will be appreciated, the ability to easily attach and detach the rope wrench 1 to a rope when at height without the use of tools is particularly convenient, as is also the ability to adjust the spacing between the bollards 4, 5 so as to match the particular size or characteristics of the climbing rope being used and/or alter the friction therebetween to suit the preferences of the climber.

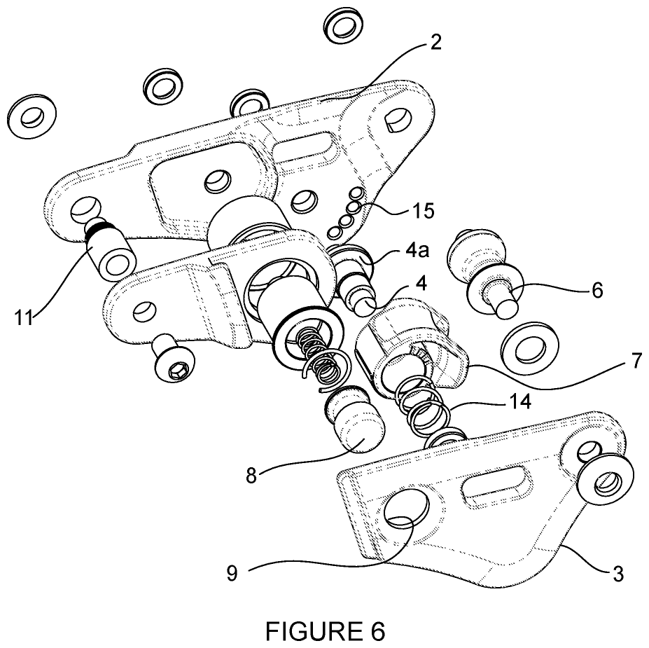

FIG. 6 shows an exploded view of the rope wrench 1 in which it will be seen that the cam 7 is biased towards the base 4a of the first bollard 4 by a spring 14 whilst permitting it to be lifted and rotated about the axis of the first bollard 4 to a chosen position denoted by one of several sockets 15 arranged radially in the base plate 2, into which a single locking pin (not shown) extending from the underside of the cam 7 can slot, to thereafter retain that position until the climber pulls the bollard 4 and hence cam 7 away from the base plate 2 against the bias of the spring 14 to move it to a different angular position. This is a particularly convenient arrangement because, once again, it allows a climber to easily adjust the rope wrench 1 when at height to fit snugly about a climbing rope and to adjust the friction being applied to the rope without the use of hand tools.

The invention in both its aspects therefore provides an elegant solution to the problem of connecting and disconnecting rope wrenches to anchored ropes at height that may already be under tension from the weight of the climber and even to adjust the rope wrench to different rope sizes or types, all without the use of tools other than the climbers' hands, having the further advantage of avoiding the possibility of dropping any such tools when at height or any parts of the rope wrench, since none of them are detachable by hand.

1. A rope wrench comprising or including a base plate having a lever arm at one end and a lever handle opposite the lever arm, a pair of bollards at the lever arm end for receiving therebetween an anchored climbing rope, and a gate spaced from the back plate and pivotable about one of the bollards, thereby permitting mid-rope access to the bollards when open and preventing mid-rope detachment when closed, the arrangement being such that when the gate is closed and the lever arm is rotated by the handle about the major axis of one of the bollards they collectively cause the rope to assume a serpentine shape to shorten the effective length of the main rope and assist ascent by the climber or to impart friction to the rope when descending whereby to permit controlled descent.

2. The rope wrench according to claim 1 wherein the gate includes a hand-operated latch by which to secure it in its closed position for use and with which to open the gate when the rope wrench is being attached or detached from an anchored rope.

3. The rope wrench according to claim 1 wherein one of the two bollards includes a rotatable cam by which to vary the distance between them to suit rope diameter or rope type.

4. The rope wrench according to claim 3 the bollard with the cam includes a spring-biased indexing arrangement whereby particular angular positions of the cam can be selected as required.

5. The rope wrench according to claim 3 wherein an indexing arrangement comprising a pip and socket-type of arrangement but in which the pip is replaced with a locking pin selectively engageable in one of a series of sockets, or vice versa as the case may be, by pulling the bollard away from the base plate, axially rotating it to a required angular position and releasing it, whereby to temporarily lock the bollard in the new position.
